(19) United States
(12) Patent Application Publication
(10) Pub. No.: US 2023/0367333 A1
(43) Pub. Date: Nov. 16, 2023

(54) METHOD FOR WORKING A PLOT OF LAND BY A FLEET OF AT LEAST TWO AGRICULTURAL ROBOTS

(71) Applicant: KUHN SAS, Saverne (FR)

(72) Inventors: Marie HOELLINGER, Rimling (FR); Philippe POTIER, Zittersheim (FR); Quentin LABOUREY, Ostwald (FR); Benoît JARRASSIER, Ottersthal (FR)

(73) Assignee: KUHN SAS, Saverne (FR)

(21) Appl. No.: 18/246,362

(22) PCT Filed: Sep. 14, 2021
(86) PCT No.: PCT/EP2021/075205

§ 371 Date: Mar. 23, 2023

(30) Foreign Application Priority Data
Sep. 24, 2020 (FR) 20-09696

(51) Int. Cl. G05D 1/02; A01B 79/00

(52) U.S. Cl. CPC G05D 1/0297; A01B 79/005; G05D 2201/0201

(57) ABSTRACT

A method for working a plot of land simultaneously by at least two agricultural robots operating autonomously and independently, in accordance with instructions and/or commands transmitted by a common central management and control system, includes subdividing said plot of land to be treated into at least two distinct work zones and allocating each work zone exclusively to one of the agricultural robots. At least during the working phase, the width of the majority of the work zones is equal to a multiple, greater than or equal to 1, of the working width of the agricultural robot to which it is exclusively allocated. During work on a plot of land, work zones not yet worked are exclusively allocated to various agricultural robots, respectively, in a gradual manner according to the completion of the work undertaken by the agricultural robots in the various zones allocated to them.

The present invention relates to the agricultural machinery field and more particularly to that of soil- and plant-working on a plot of land, and its subject is a method for working automatically and simultaneously a plot by a fleet of at least two agricultural machines or robots, as well as an agricultural machinery assembly to perform this method.

In the agricultural field, it is known that, where a plot is worked by a fleet of multiple autonomous agricultural vehicles (robots), the distribution of the work within the plot is crucial to guaranteeing the efficiency of the system. Similarly, it is vital to avoid possible collisions between the various vehicles as much as possible.

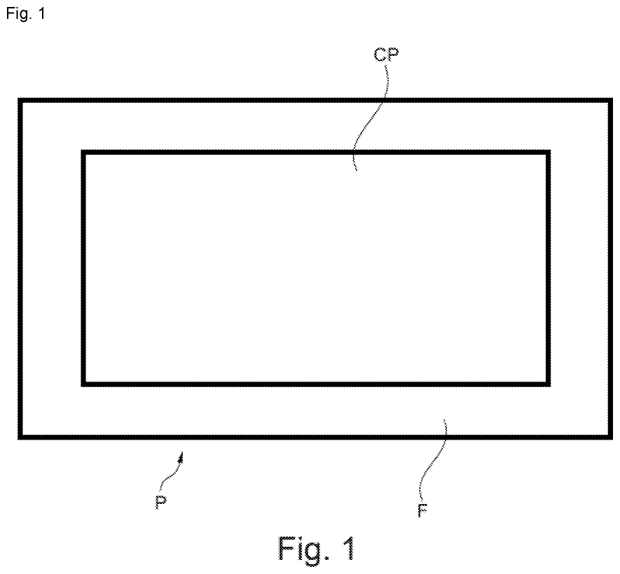

Typically, a plot P is divided into a main field CP (optimally exploitable surface area) and a headland area F that borders all or part of the peripheral circumference of this main field (see FIG. 1—headland all around the field). This headland is used by the vehicles to manoeuvre from one row of the main field to the next (U-turns, for example).

In a known and usual manner, the autonomous vehicles in a same fleet communicate with one another (by radio frequency, directly or via a central system) in order to constantly know the position of the others. Other solutions of the master/slave type also exist (a slave robot follows and reproduces the path of a master robot).

However, these known solutions necessitate constant bidirectional exchanges and therefore permanent communication between the robots: this means complex requirements in terms of data streams and connections between the vehicles and the network.

Alternatively, the known solutions of the master/slave type require the slave robot(s) to be dependent on the master robot(s): the two types of vehicles can therefore not really work independently, but only as pairs or in groups, which reduces efficiency. Furthermore, once again the robot(s) have to be managed by means of a permanent communication link.

Finally, other solutions recommend dividing the plot to be worked into work zones of fixed width corresponding to the working width of the agricultural robots used and to assign these plots to the various robots, these plots being assigned/reassigned in real time according to the progress of the work by the various robots and the development of the situation. One solution of this type is disclosed by document EP 3 508 045 or US 2019/0146513.

Although this latter type of solution does not require permanent communication, the exchanges between the centralised management system and the robots are frequent and the solution is inflexible. Moreover, the path of the machines is not really known in advance. In addition, management of collisions between robots can rapidly become very complex.

The purpose of the present invention is in particular to overcome the drawbacks of this latter type of solution.

To this end, its subject is a method for working a plot simultaneously by a fleet of at least two autonomous and independent agricultural machines or robots, according to instructions and/or commands transmitted by a common central management and control system, method characterised in that it consists in subdividing the plot to be processed, prior to the start of work on this plot or progressively during its work, into at least two distinct work zones, the whole of the work zones advantageously substantially covering all of the exploitable surface area of the plot and each work zone consisting of a fraction of the plot in the form of a strip, and assigning each work zone exclusively to one of the agricultural robots, at least during the considered work phase, the width of the majority of the work zones being equal to a multiple of, greater than or equal to 1 and preferentially an integer, the working width of the agricultural robot exclusively assigned to it; and the exclusive assignment, during work on the plot, of the work zones not yet worked, respectively to the various agricultural robots, being achieved progressively according to the completion of work in the various work zones by the agricultural robots that have respectively been assigned to them.

The invention will be better understood from the following description, which refers to preferred embodiments, given as non-limiting examples, and explained with reference to the attached schematic drawings all illustrating from above agricultural plots, in which:

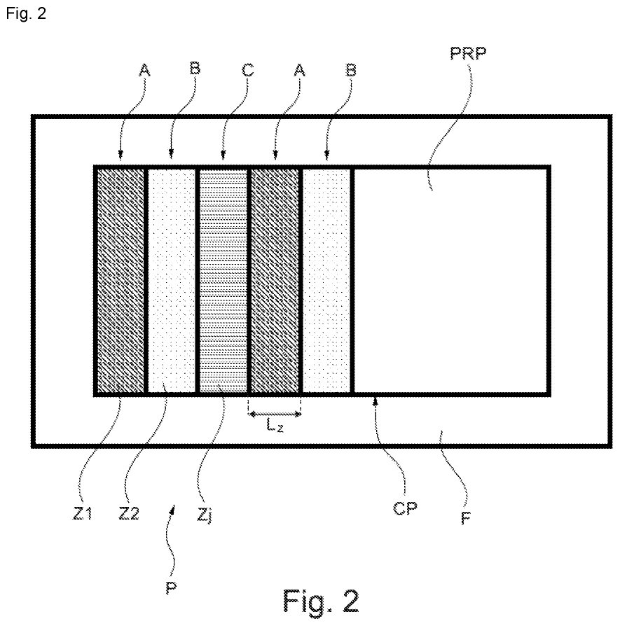

FIG. 2 shows, for a rectangular plot, a partial division of the field with alternating work zones according to a repetitive pattern or scheme of the type A-B-C, A-B-C, etc.;

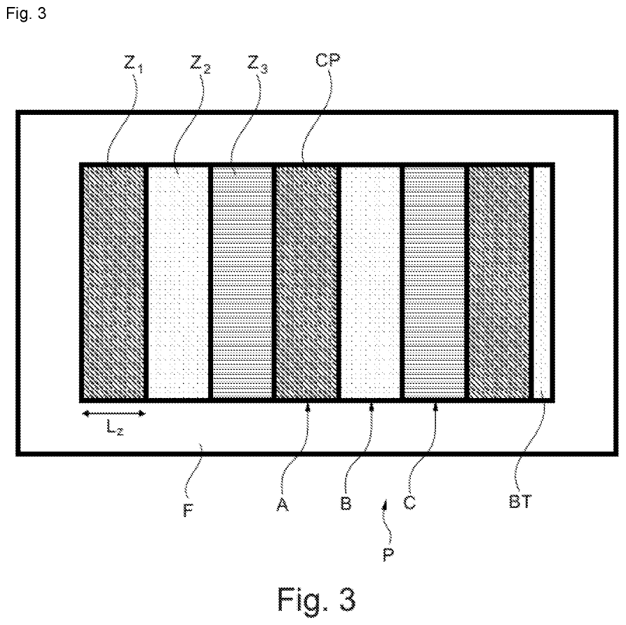

FIG. 3 shows a total division of the field with alternating uniform work zones according to the same repetitive pattern or scheme as that in FIG. 2 (type A-B-C, A-B-C, etc.) and with a (terminal) strip of different (narrower) width;

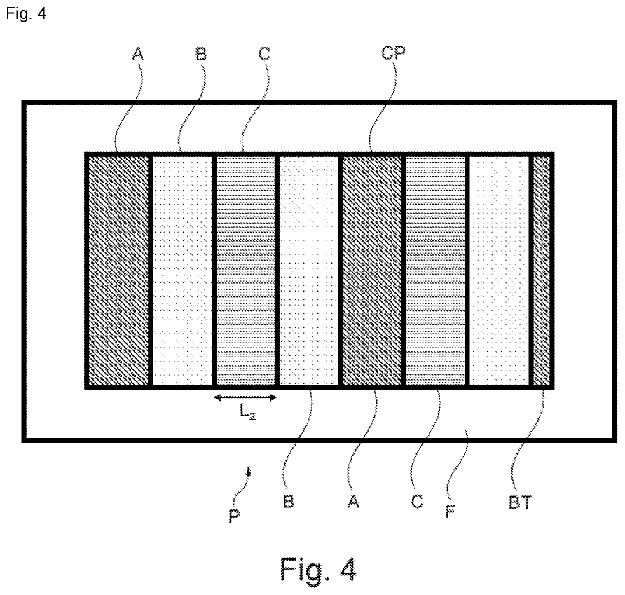

FIG. 4 shows a total division of the field with alternating uniform work zones according to a different repetitive pattern or scheme to that in FIG. 3 (type A-B-C, B-A-C, B-A- etc.) and with a (terminal) strip of a different size;

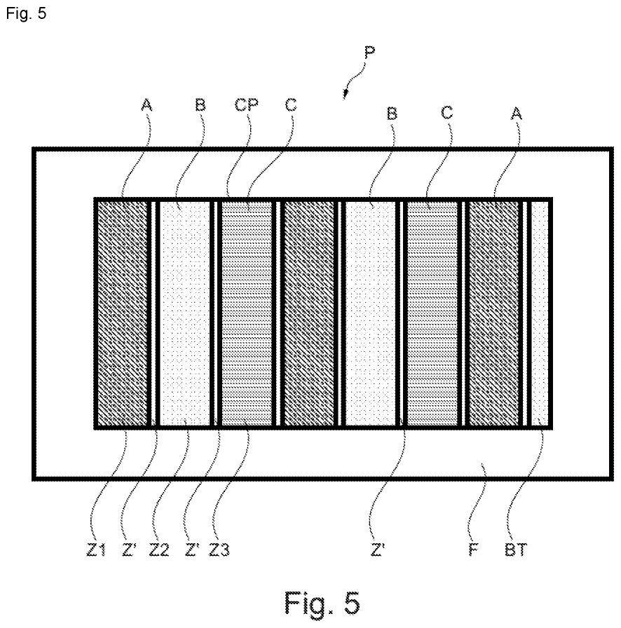

FIG. 5 shows a total division of the field with alternating uniform work zones according to the same repetitive pattern or scheme as that in FIG. 2 (type A-B-C, A-B-C, etc.), but with a (terminal) strip of different size and intermediate “empty” strips not worked by the agricultural robots;

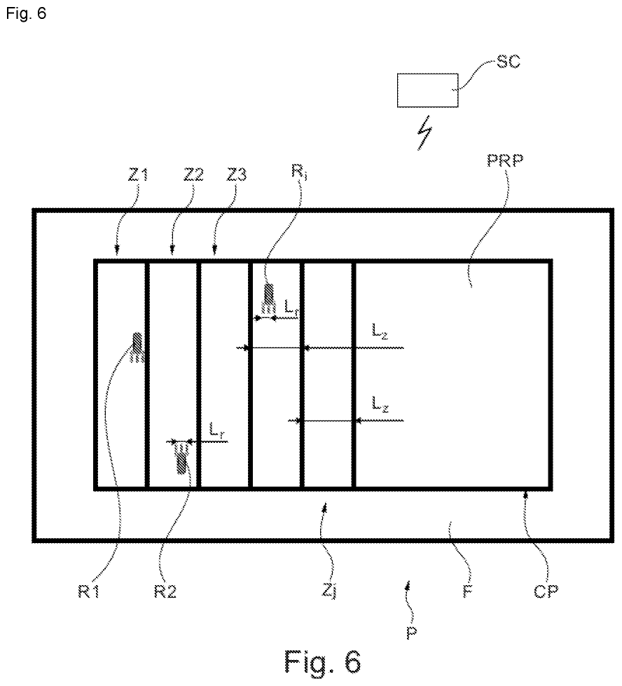

FIG. 6 shows a partial division of the field with alternating work zones, showing the main constituent components of an example agricultural machinery assembly for carrying out the method according to the invention (common central management and control system—autonomous robotic vehicles for agricultural work);

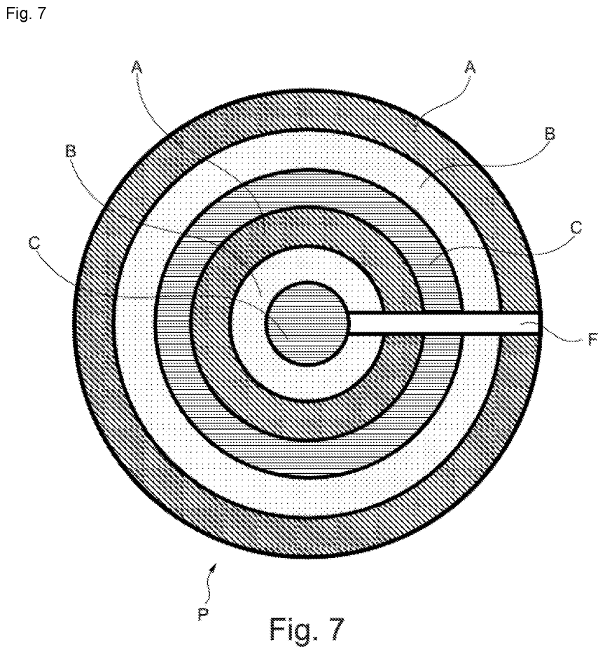

FIG. 7 shows, for a plot with a circular configuration, a total division of the field with alternating work zones according to a repetitive pattern or scheme of the type A-B-C, A-B-C, etc. (as for FIGS. 2 and 3) and with a central headland strip (extending along a radius);

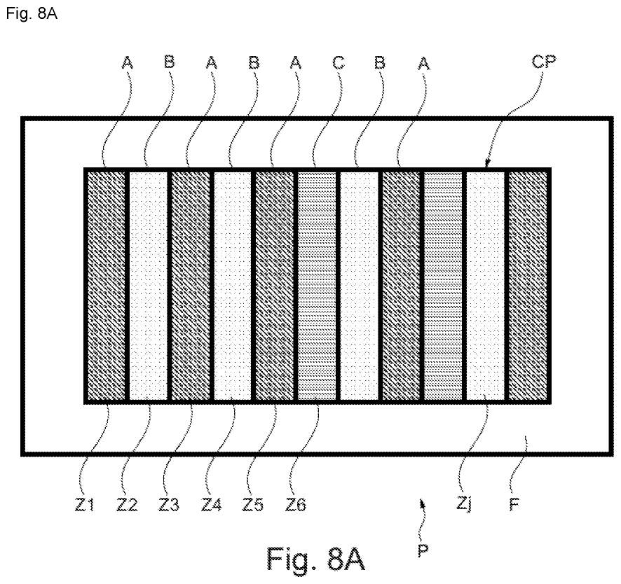

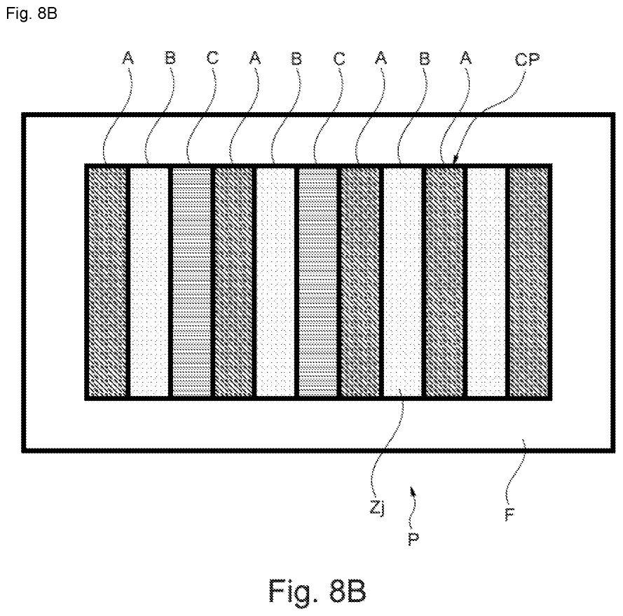

FIG. 8A and

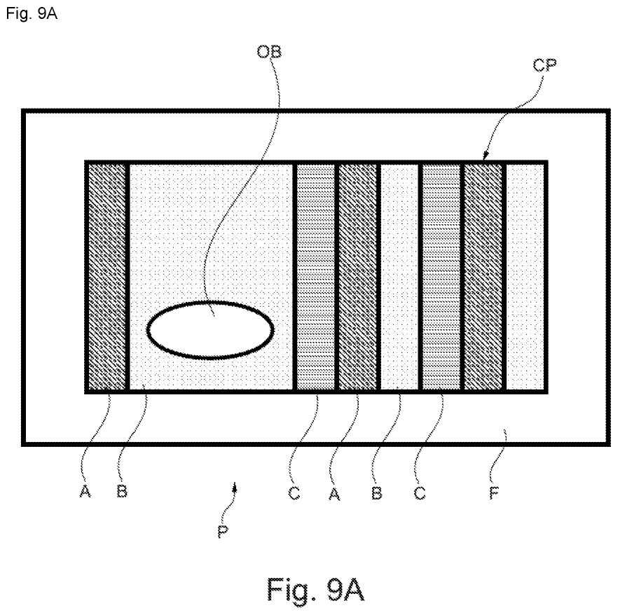

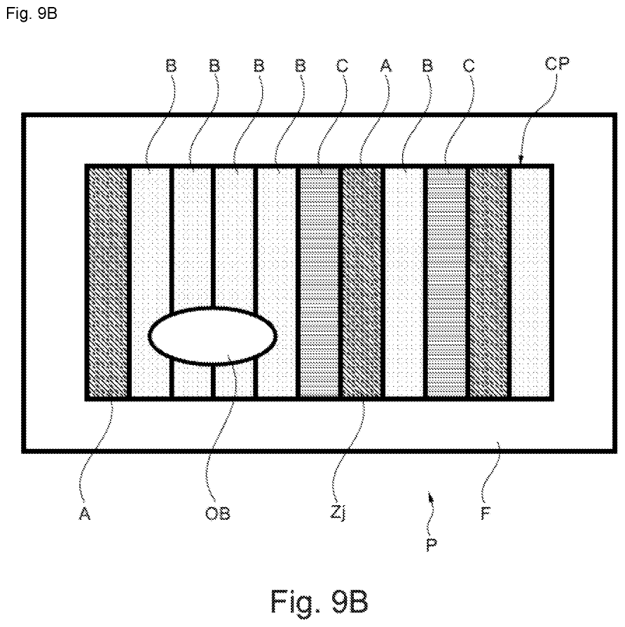

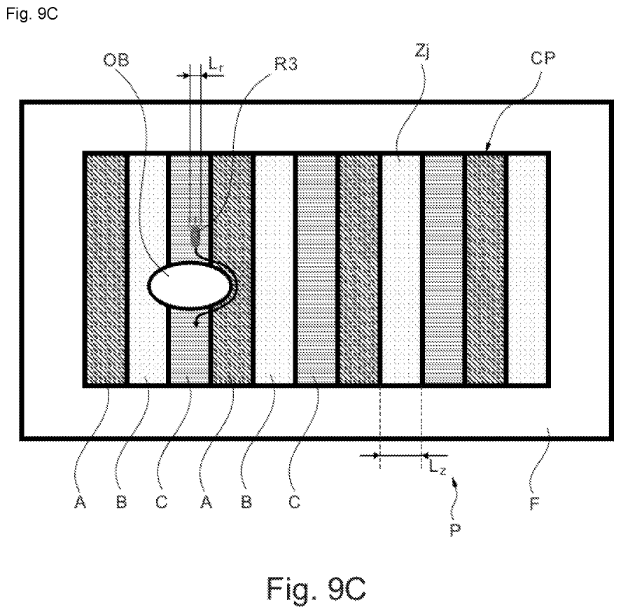

FIG. 8B are representations similar to those in FIGS. 2 to 5, respectively illustrating the addition of a robotic vehicle (FIG. 8A) and the removal of a robotic vehicle (FIG. 8B) during execution of the work method on a plot according to the invention and,

[FIG. 9A],

FIG. 9B and

FIG. 9C are representations similar to those in FIGS. 2 to 5 respectively illustrating different examples of methods of managing the presence of an obstacle of relatively large size (in particular, greater for example than the width of a work zone) in accordance with the invention.

As shown in FIGS. 2 to 9, the subject of the present invention is a method for working a plot (P) simultaneously by a fleet of at least two autonomous and independent agricultural machines or robots (R1, R2, . . . , Ri), according to instructions and/or commands transmitted by a common central management and control system (SC).

The work performed by the robots may cover all current agricultural operations (working the soil from preparation before sowing until treatment after harvesting) and be dependent on the type of crop, the season, the nature of the soil, the meteorological conditions, etc.

In accordance with the invention, this method consists in subdividing the plot (P) to be worked, prior to the start of work on this plot (P) or progressively during its work, into at least two distinct work zones (Z1, Z2, . . . , Zj), the whole of the work zones advantageously substantially covering all of the exploitable surface area of the plot and each work zone consisting of a fraction of the plot in the form of a strip, and assigning each work zone (Z1, Z2, Zj) exclusively to one of the agricultural robots (R1, R2, Ri), at least during the considered work phase. The width (Lz) of each work zone (Z1, Z2, Zj) is equal to a multiple, greater than or equal to 1 and preferably an integer, of the working width (Lr) of the agricultural robot (R1, R2, Ri) exclusively assigned to it. Furthermore, the exclusive assignment, during work on the plot (P), of the work zones (Z1, Z2, Zj) not yet worked, respectively to the various agricultural robots (R1, R2, Ri), being achieved progressively according to the completion of work in the various work zones by the agricultural robots that have respectively been assigned to them.

Thus, in accordance with the invention, the exploitable surface area CP of the considered plot P (or main field) is divided into work zones, each allocated exclusively to one robot in the fleet present. The zone reserved for a robot can only be travelled by the latter for the duration of the work that it has to do there: it works this zone independently, according to its programming (and/or specific instructions sent by the central system before the start and/or for the duration of the work in the plot or in the considered zone) and without being disrupted by any other robot present on the plot.

Thanks to the aforementioned provisions, the solution provided by the invention makes it possible to significantly simplify the management of conflicts and collisions between robots, to manage work in each work zone independently, to allow great flexibility in the number of vehicles working simultaneously on a given plot and above all to be free from the need for communication between robots, as each of them only works within the limits of a zone that has been exclusively allocated to it.

Furthermore, the robots do not need to know their respective positions. Effectively, the robots' movements are managed centrally by the central management and control system, which also controls allocation of the work zones, definition of the working parameters of each robot, etc. Each robot therefore communicates exclusively with the management and control system and not with any other robot.

In addition, the method according to the invention makes it possible easily to adapt to additions/removals of robots during work on a plot (see FIG. 8) and to have work zones of different widths, thereby also making it possible to find an optimal compromise in the movements of the robots between successive zones to be worked.

Finally, it is also possible easily to implement U-turns, manoeuvres or supply zones at the two ends of the work zones, in the exclusive headland areas respectively associated with the work zones.

Thus, robots crossing paths in the headland areas can be limited or even totally avoided.

As shown by the attached figures, by way of examples, the subdivision into zones in the form of successive adjacent strips follows an order of succession from one end to the other of the considered plot; the different strips may be all of identical width, all different or for some different and for others identical. The number of work zones obtained after the subdivision is preferably greater or at least equal to the number of robots intended to work the plot.

The scheme for allocating the different work zones to the different robots, at the start or during a work cycle on a given plot, may follow predetermined rules and logic; for example, an imposed arbitrary scheme, a regular repetition, an assignment according to the progress of each robot's work, an assignment according to the first unallocated zone in the topographical order of succession of the pre-divided-zones, etc.

In accordance with a first embodiment, shown for example in FIGS. 3 to 5 and 7, it may be provided that after an initial assignment of a first work zone exclusive to each agricultural robot, the following assignments, during work on the plot (P), of the work zones that have yet to be worked (to the different agricultural robots) is carried out progressively according to completion of the work in progress in the various work zones by the agricultural robots effectively assigned to them.

In accordance with a second embodiment, shown in FIGS. 2 and 6, it may be provided that all of the work zones (Z1, Z2, Zj) are allocated to the various agricultural robots (R1, R2, Ri), with an exclusive assignment of one robot per zone, at the start of work on the plot (P), with a possible reallocation of the yet unworked work zones, between the various considered agricultural robots, that may take place at a determined moment during work on the plot (P), according to the development of the behaviour, the availability and/or the status of the various robots, or even the actual or foreseeable progress of the work in the work zones still being worked at that determined moment by the respective robots that have been exclusively assigned to them.

The cases of adding and removing a robot are illustrated schematically by the work zone patterns in FIGS. 8A and 8B.

Preferably, at least the initial assignment or first assignment of the exclusive work zones (Z1, Z2, Zj) follows an allocation rule (alternative, cyclic, repetitive or arbitrary) for the various robots in the successive adjacent work zones resulting from the subdivision of the plot (P). As FIGS. 2 to 9 show, these work zones can consist of strips either arranged side to side and substantially straight, in the case of a polygonal plot (P) with at least a partial peripheral headland (F) (FIGS. 2 to 6, 8 and 9), or of substantially circular (annular) strips arranged concentrically to one another, in the case of a disc-shaped plot (P) with a headland (F) extending along a radius (FIG. 7).

In order to rationalise and unify the operations simultaneously performed by multiple robots on a given plot, it is advantageously envisaged to use agricultural robots (R1, R2, Ri) performing the same type of work, the robots preferably having identical working widths (Lr), and advantageously being of the same type. Nevertheless, robots with different working widths (Lr), but performing the same type of work, may also be used in the context of the invention (for example, models of different sizes of a same type of robot). In the latter case, the work zones could have different adapted widths (Lz) (not shown).

Where applicable, two different fleets of robots performing complementary work may be active at the same time on a same plot, in particular a large-sized plot, a first fleet finishing the work assigned to it while the other fleet starts its own, preferably at two opposite ends of the plot.

In order for example to avoid any risk of collisions between robots working in neighbouring zones, potentially to have unworked strips for access and/or to leave strips in fallow or of differentiated crops, it may be envisaged, as shown in FIG. 5, to provide an intermediate zone (Z′), between at least two adjacent work zones (Z1, Z2, Zj), in the form of a strip (for example from a few centimetres to a few dozen centimetres) that should not be worked by the agricultural robots (R1, R2, Ri).

According to another possible functional characteristic of the invention, the method may potentially consist of performing a new assignment of the work zones (Z1, Z2, Zj) not yet worked to the various agricultural robots (R1, R2, Ri) present and operational, when adding a new robot, when a robot is withdrawn or leaves, or when an active robot is stopped in a work zone, this reassignment being operated by the common central management and control system (SC) and transmitted to the various robots; where applicable, after making a new subdivision of the remaining part (PRP) of the plot (P) yet to be processed at that moment.

In accordance with another possible characteristic of the invention, the subdivision of the plot (P) and the allocation of the exclusive work zones (Z1, Z2, Zj) to the various agricultural robots (R1, R2, Ri) may take into account minimising the crossing of the robots in the headland(s) (F) when changing work zones.

The agricultural operations are, in accordance with the invention, performed independently in each zone by the various robots of the fleet assigned to the plot; adjustments of work parameters specific to each zone being of course possible, which are suitable in particular for different desired or experienced operational situations, such as, for example:
for a sloping zone, the working speed may be slower;
for a zone with a different soil composition (stones, clay, sand, etc.), the working depth and/or adjustments of the tools and/or vehicles may be specific;
for particular and differentiated local conditions: possibility of varying the doses of products applied to each zone (density of seeds, plant protection products, irrigation, type of operation performed, etc.);
for flexible operation of the plot: possibility of seeding different varieties in each zone.

Moreover, concerning the definition and allocation of the work zones, the following considerations may be envisaged:
the sizes of the work zones may be influenced by factors other than the working width of the agricultural robot: tool adjustments, topographical and/or geographical constraints may have greater importance;
the width Lz of a given work zone may be less than the working width Lr of the robot assigned to it: see in particular the last zones or terminal strips BT in FIGS. 3 to 5 (ends of plots, etc.);
the next work zone allocated to a given robot is not necessarily adjacent to or “stuck to” the one that this robot has just finished (unworked zones can be skipped, in order of succession by proximity);
the end of the task to be performed in a work zone does not necessarily correspond to performance of the work by the robot assigned over 100% of the surface area of the concerned zone: the logic of allocation applied by the central system (SC) may potentially decide to make the robot pass to a subsequent zone while the work in the zone currently being worked is not completely finished (broken down robot, time-saving, limitation of unnecessary manoeuvres, etc.);
when a given robot changes work zone, the zone in which it has just finished its work is “freed” and another robot can enter that zone to perform other work.

A delicate problem may arise if there is an obstacle (natural or other), in particular if it is of relatively significant size (large rock, pylon, mound, lake, etc.) in the plot to be worked.

Many solutions may be envisaged and implemented to avoid the agricultural robots leaving their respective work zones to avoid the obstacle:
define a large work zone that includes the whole obstacle (OB) as shown for example in FIG. 9A;
define work zones of standard widths and “reserve” several adjacent zones including the obstacle (OB) for a same robot, as represented in FIG. 9B;
define work zones of standard widths and force the concerned robot to pass through another adjacent zone, having waited for it to be freed before crossing it, as shown in FIG. 9C.

In all cases, the obstacle and the way in which it is bypassed should be taken into account for the definition of the size of the zones and for the logic of their allocation to the concerned robots (managed by the central management and control system).

Processing of the headlands, and the work performed therein, may advantageously be based on a specific logic (on this subject see the patent application submitted in parallel on this day by the applicant).

One can see that all of the plots do not necessarily have headlands (zones F) that go all the way around the exploitable surface area (main field CP), they may only be present on two sides (only at the top and at the bottom in the attached figures for example).

It is also possible to have no headland at all, with the manoeuvres being performed within the main field itself (overlapping between plot and main field), without this changing the principle of the invention.

Finally, when the headland(s) is (are) considered part of the exploitable surface area of the plot, the latter may be worked either by portions by each of the robots assigned to the different work zones (at the ends of the latter), or by at least one dedicated robot treating it as a specific work zone, at least one other robot (advantageously more) thus being assigned to work in the main field. In a minimal configuration, just two robots can be used (one for the main field and one for the headland).

The invention also relates, as schematically shown in FIG. 6, to an agricultural machinery assembly for the automated working of plots (P).

This assembly essentially comprises a fleet of at least two autonomous and independent agricultural machines or robots (R1, R2, . . . , Ri) that are mobile and equipped with appropriate tools, and a common central management and control system (SC) suitable for communicating with the robots in order to send them instructions and/or commands and in return to receive information on the operation and/or status of the robots, each robot furthermore being equipped with a satellite positioning or tracking device.

This assembly is characterised in that the central management and control system (SC) comprises means making it possible, on one hand, to subdivide said plot (P) to be processed, prior to the start of work on this plot (P) and/or progressively during its work, into at least two distinct work zones (Z1, Z2, . . . , Zj), the whole of the work zones advantageously substantially covering all of the exploitable surface area of the plot and each work zone consisting of a fraction of the plot in the form of a strip and, on the other hand, to assign each work zone (Z1, Z2, Zj) exclusively to one of the agricultural robots (R1, R2, Ri), at least during the considered work phase, the width (Lz) of the majority of the work zones (Z1, Z2, Zj) being greater than or equal to the working width (Lr) of the agricultural robot (R1, R2, Ri) exclusively assigned to it, by being advantageously equal to a multiple, preferentially an integer, of the working width (Lr) of the agricultural robot (R1, R2, Ri) exclusively assigned to it; and the exclusive assignment, during work on the plot (P), of the work zones (Z1, Z2, Zj) not yet worked to the various agricultural robots (R1, R2, Ri), being achieved progressively according to the completion of work in the various work zones by the agricultural robots that have respectively been assigned to them.

This assembly implements the method described previously to manage the fleet of robots (R1, R2, Ri) during the working of a plot (P).

Of course, the invention is not limited to the embodiments described and shown in the attached drawings. Modifications remain possible, in particular concerning the composition of the various elements or by substitution of technical equivalents without departing from the scope of protection of the invention.

1-11. (canceled)

12. A method for working a plot simultaneously by a fleet of at least two autonomous and independent agricultural machines or robots, according to instructions and/or commands transmitted by a common central management and control system, the method comprising
subdividing the plot to be processed, prior to a start of work on the plot or progressively during the work, into at least two distinct work zones, a whole of the work zones substantially covering all of an exploitable surface area of the plot and each work zone including a fraction of the plot in a form of a strip, and
assigning each work zone exclusively to one of the agricultural robots, at least during the work, a width of a majority of the work zones being equal to a multiple, greater than or equal to 1, of a working width of the one of the agricultural robots exclusively assigned; and the exclusive assignment, during the work on the plot, of one of the work zones not yet worked, respectively to various agricultural robots, being achieved progressively according to a completion of the work in the various work zones by the agricultural robots that have respectively been assigned.

13. The method according to claim 12, wherein after an initial assignment of a first work zone exclusive to each agricultural robot, following assignments, during the work on the plot, of the work zones that have yet to be worked to different agricultural robots are carried out progressively according to completion of the work in the various work zones by the agricultural robots respectively assigned.

14. The method according to claim 12, wherein all of the work zones are allocated to the various agricultural robots, with an exclusive assignment of one robot per zone, at the start of the work on the plot, with a possibility of reallocation of yet unworked work zones, between various considered agricultural robots, taking place at a determined moment during the work on the plot, according to a development of a behavior, an availability and/or a status of the various robots, or an actual or foreseeable progress of the work in the work zones still being worked at that determined moment by the respective robots that have been exclusively assigned.

15. The method according to claim 12, wherein at least an initial assignment or first assignment of the exclusive work zones follows an alternative, cyclic, repetitive or arbitrary allocation rule, for the various robots in successive adjacent work zones resulting from a subdivision of the plot, the work zones consisting either of substantially straight strips arranged side by side, in a case of a polygonal plot with at least a partial peripheral headland, or of substantially circular strips arranged concentrically to one another, in a case of a disc-shaped plot with a headland extending along a radius.

16. The method according to claim 12, further comprising implementing agricultural robots performing a same type of work, the robots having identical working widths, and being of the same type.

17. The method according to claim 12, further comprising providing, between at least two adjacent work zones, an intermediate zone in a form of a strip that should not be worked by the agricultural robots.

18. The method according to claim 12, further comprising performing a new assignment of the work zones not yet worked to the various agricultural robots present and operational, when adding a new robot, when a robot is withdrawn or leaves, or when an active robot is stopped in a work zone, a reassignment being operated by the common central management and control system and transmitted to the various robots.

19. The method according to claim 12, wherein a subdivision of the plot and an allocation of the exclusive work zones to the various agricultural robots take into account minimizing a crossing of the robots in headland(s) when changing work zones.

20. The method according to claim 12, wherein a movement of an agricultural robot in a work zone that has been exclusively allocated is defined so that the agricultural robot does not cross paths with a robot from an adjacent or adjoining work zone, at mutually abutting borders of the two zones.

21. Agricultural machinery assembly for an automated working of plots including a fleet of at least two mobile autonomous and independent agricultural machines or robots, equipped with appropriate tools, and a common central management and control system suitable for communicating with the robots in order to send the robots instructions and/or commands and in return to receive information on an operation and/or status of the robots, each robot furthermore being equipped with a satellite positioning or tracking device, wherein
the central management and control system includes means is configured to,
on one hand, subdivide the plot to be worked, prior to a start of the work on the plot and/or progressively during the work, into at least two distinct work zones, a whole of the work zones substantially covering all of an exploitable surface area of the plot and each work zone including a fraction of the plot in a form of a strip and,
on the other hand, to assign each work zone exclusively to one of the agricultural robots, at least during the work, a width of a majority of the work zones being greater than or equal to a working width of the one of the agricultural robots exclusively assigned, by being advantageously equal to a multiple of the working width of the agricultural robot exclusively assigned; and the exclusive assignment, during the work on the plot, of one of the work zones not yet worked to the various agricultural robots being achieved progressively according to a completion of the work in the various work zones by the agricultural robots that have respectively been assigned.

22. The assembly according to claim 21, wherein the assembly implements a method for working a plot simultaneously by a fleet of at least two autonomous and independent agricultural machines or robots, according to instructions and/or commands transmitted by a common central management and control system, the method comprising subdividing the plot to be processed, prior to a start of work on the plot or progressively during the work, into at least two distinct work zones, a whole of the work zones covering an exploitable surface area of the plot and each work zone including a fraction of the plot in a form of a strip, and assigning each work zone exclusively to one of the agricultural robots, at least during the work, a width of a majority of the work zones being equal to a multiple, greater than or equal to 1, of a working width of the one of the agricultural robots exclusively assigned; and the exclusive assignment, during the work on the plot, of one of the work zones not yet worked, respectively to various agricultural robots, being achieved progressively according to a completion of the work in the various work zones by the agricultural robots that have respectively been assigned to manage the fleet of robots during the working of the plot.

23. The assembly according to claim 21, wherein the multiple is an integer great than or equal to 1.

24. A method for working a plot simultaneously by a fleet of at least two autonomous and independent agricultural machines or robots, according to instructions and/or commands transmitted by a common central management and control system, the method comprising
subdividing the plot to be processed, prior to a start of a work on the plot or progressively during the work, into at least two distinct work zones, a whole of the work zones covering an exploitable surface area of the plot and each work zone including a fraction of the plot in a form of a strip, and
assigning each work zone exclusively to one of the agricultural robots, at least during the work, a width of a majority of the work zones being equal to a multiple of a working width of the one of the agricultural robots exclusively assigned; and the exclusive assignment, during the work on the plot, of one of the work zones not yet worked, respectively to various agricultural robots, being achieved progressively according to a completion of the work in the various work zones by the agricultural robots that have respectively been assigned.

25. The method according to claim 24, wherein the multiple is an integer greater than or equal to 1.

26. The method according to claim 12, wherein the multiple is an integer greater than or equal to 1.
